(19) United States
(12) Patent Application Publication
(10) Pub. No.: US 2026/0253249 A1
(43) Pub. Date: Aug. 27, 2026

(54) HOLISTIC APPROACH FOR VISUAL SIMULTANEOUS LOCALIZATION AND MAPPING IN GLOBAL NAVIGATION SATELLITE SYSTEM SIGNAL-DENIED ENVIRONMENTS

(71) Applicant: GM GLOBAL TECHNOLOGY OPERATIONS LLC, Detroit, MI (US)

(72) Inventors: Shuqing Zeng, Sterling Heights, MI (US); Bo Yu, Troy, MI (US); Kamran Ali, Troy, MI (US); Tarek A. R. Abdel Rahman, Cedar Park, TX (US); Guanyang Luo, Warren, MI (US); Ryan A. Sierzega, Seattle, WA (US); Fan Bai, Ann Arbor, MI (US); Xiang Gao, Rochester Hills, MI (US)

(21) Appl. No.: 19/062,414

(22) Filed: Feb. 25, 2025

(51) Int. Cl. G06T 7/73; G01S 19/01; G06V 20/56

(52) U.S. Cl. CPC G06T 7/73; G01S 19/01; G06V 20/56; G06T 2207/10028

(57) ABSTRACT

A Visual Simultaneous Localization and Mapping (V-SLAM) system for a mobile host includes a camera for sensing and outputting image data indicative of features of interest in a surrounding environment of the host. A global navigation satellite system (GNSS) receiver determines a position of the host on a route as GNSS data. A controller localizes the mobile host on a route using the GNSS data and a semantic submap when a signal quality of the GNSS receiver exceeds a threshold. When the signal quality does not exceed the threshold, the controller selectively localizes the mobile host on the route at least in part using a crowdsourced three-dimensional (3D) point cloud map of the route. The V-SLAM system communicates the image data and the GNSS data to a cloud-based backend architecture operable for generating the crowdsourced 3D point cloud map of the route.

### INTRODUCTION

Autonomous vehicles, robots, and other mobile host systems may use a Visual Simultaneous Localization and Mapping (V-SLAM) system to detect and comprehend features in a surrounding environment. A typical V-SLAM system employs cameras to capture real-time visual information/image data about the environment. The V-SLAM system processes the collected image data and estimates the camera's position and orientation/pose, corrects accumulated errors, and generates environmental maps, e.g., for use by an onboard navigation system of the mobile host system.

A V-SLAM system is generally operable for detecting distinct corners, edges, and other relevant map features. The V-SLAM system also attempts to match imaged map features across different image frames and camera/host system poses. Corresponding feature map points are then triangulated in free space when identifying matched features. A three-dimensional (3D) point cloud map is thereafter constructed from feature map points in the collective set of map features to describe key features in the surrounding environment. A controller connected to the V-SLAM system or integrally included therewith is able to locate the mobile host system on a navigation map, a road surface, within a manufacturing plant, or in another environment, thus improving overall navigation accuracy.

### SUMMARY

Disclosed herein is a holistic approach for performing Visual Simultaneous Localization and Mapping (V-SLAM) in a Global Navigation Satellite System (GNSS) signal-denied environment for optimized localization accuracy of a mobile host system. The solutions described herein selectively utilize a crowdsourced feature point cloud, e.g., from a backend architecture, to inform location capabilities in a positioning signal-denied area such as an urban canyon. Poor signal quality reduces position accuracy, often by several meters or more relative to when a GNSS signal is strong and reliable. The present teachings are therefore intended to provide a smooth transition between GNSS-based localization and the use of semantic submaps and hybrid semantic/V-SLAM-based localization in such environments.

In particular, a V-SLAM system for a mobile host includes a camera, a GNSS receiver, and a controller. The camera is operable for sensing and outputting image data indicative of features of interest in a surrounding environment of the mobile host. The receiver is operable for determining a position of the mobile host on a route by receiving satellite-based positioning data. The controller, which is in communication with the camera, includes a processor and a computer storage medium (“memory”) containing computer-readable instructions.

Execution of the instructions by the processor causes the controller to localize the mobile host on a route using data point cloud map and a semantic submap when a signal quality of the GNSS receiver exceeds a threshold. When the signal quality does not exceed the threshold, the controller selectively localizes the mobile host on the route at least in part using a crowdsourced three-dimensional (3D) point cloud map of the route, wherein V-SLAM system is operable for communicating the image data and the GNSS data to a cloud-based backend architecture operable for generating the crowdsourced 3D point cloud map of the route.

The mobile host may be an autonomous vehicle, with the controller operable for controlling a dynamic state of the autonomous vehicle in response to localizing the mobile host.

The controller may be configured as part of a frontend architecture that is in remote communication with the cloud-based backend architecture, and that is configured to receive the crowdsourced 3D point cloud map of the route in response to a request from the controller. In such an embodiment, the controller receives the crowdsourced 3D point cloud map of the route as a fused map of the 3D point cloud and the semantic submap.

The V-SLAM system may include an inertial measurement unit (IMU) operable for outputting IMU data. The controller in such an embodiment is configured to locally optimize key features in the image data using the GNSS data and the IMU data.

The controller may also estimate a current pose of the mobile host by minimizing errors between the IMU data, the 3D point cloud map, and the semantic submap. The controller may be configured to minimize the errors by minimizing a least squares expression of the IMU data, the 3D point cloud map, and the semantic submap.

Also disclosed herein is a V-SLAM method for a mobile host. An embodiment of the method includes sensing and outputting image data via a camera of the mobile host, with the image data being indicative of features of interest in a surrounding environment of the mobile host. The method includes determining a position of the mobile host on a route as GNSS data using a GNSS receiver of the mobile host, and also localizing the mobile host on the route using the GNSS data and a semantic submap when a signal quality of the GNSS receiver exceeds a threshold.

When the signal quality does not exceed the threshold, the method includes selectively localizing the mobile host on the route via a controller of a V-SLAM system at least in part using a crowdsourced three-dimensional (3D) point cloud map of the route. The controller in this instance communicates the image data and the GNSS data to a cloud-based backend architecture operable for generating the crowdsourced 3D point cloud map of the route.

An aspect of the present disclosure includes a V-SLAM system having a frontend architecture and a backend architecture. The frontend architecture is inclusive of a camera, a GNSS receiver, and a controller. The camera is mounted to a mobile host and operable for sensing and outputting image data indicative of features of interest in a surrounding environment of the mobile host. The receiver is operable for determining a position of the mobile host on a route as GNSS data. The controller is in communication with the camera and the GNSS receiver, and is operable for communicating the image data and the GNSS data to a cloud-based backend architecture.

The cloud-based backend architecture in this implementation is operable for aggregating and aligning crowdsourced sensor data from a plurality of mobile hosts into a crowdsourced 3D point cloud map. The V-SLAM system is operable for localizing the mobile host on a route using the GNSS data and a semantic submap when a signal quality of the GNSS receiver exceeds a threshold. When the signal quality does not exceed the threshold, the V-SLAM system selectively localizes the mobile host on the route at least in part using the crowdsourced 3D point cloud map of the route.

The above-noted and other features and advantages of the present teachings, are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 schematically illustrates a representative mobile host operating in a positioning signal-denied environment, with the mobile host including a Visual Simultaneous Localization and Mapping (V-SLAM) system configured as a frontend architecture as set forth herein.

FIG. 2 is a block diagram of a representative submap handoff or transition in accordance with an aspect of the disclosure.

FIG. 3 illustrates a representative location accuracy improvement using crowdsourced vehicle sensor data in accordance with the disclosure.

FIG. 4 illustrates a representative frontend architecture that is usable as part of the present strategy.

FIG. 5 illustrates a representative cloud-based/backend architecture usable as part of the present strategy.

FIG. 6 is a flow diagram illustrating a possible construction of a backend map within the scope of the disclosure.

FIG. 7 is a flow diagram illustrating aspects of a frontend construction in accordance with the disclosure.

FIG. 8 is a diagram describing a frontend localization pipeline of FIGS. 6 and 7.

FIG. 9 is a flow chart describing a method in accordance with the disclosure.

The appended drawings are not necessarily to scale and may present a simplified representation of various preferred features of the present disclosure as disclosed herein, including specific dimensions, orientations, locations, and shapes. Details associated with such features will be determined in part by the particular intended application and use environment.

### DETAILED DESCRIPTION

Components of the embodiments disclosed herein may be arranged in a variety of possible configurations. Therefore, the following detailed description is not intended to limit the scope of the disclosure as claimed, but is merely representative of possible embodiments thereof. In addition, while numerous specific details are set forth in the following description in order to provide a thorough understanding of various representative embodiments, some embodiments are capable of being practiced without some of the disclosed details. In order to improve clarity, certain technical material understood in the related art has not been described in detail. Furthermore, the disclosure as illustrated and described herein may be practiced in the absence of an element that is not specifically disclosed herein.

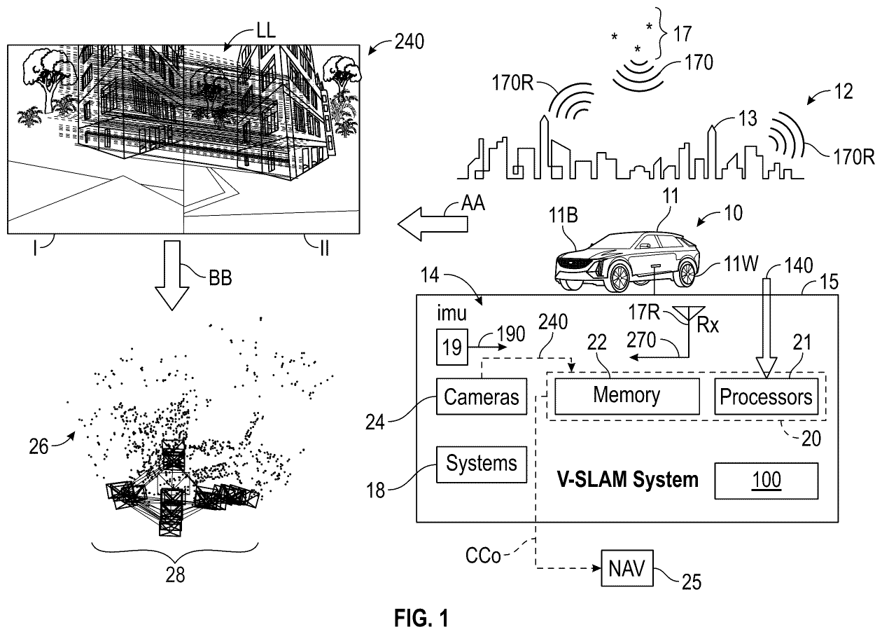

Referring now to the drawings, wherein like reference numbers refer to like features throughout the several views, FIG. 1 depicts a mobile host 10. The mobile host 10 is illustrated in the representative form of an autonomous vehicle 11, e.g., a fully autonomous or semi-autonomous battery electric, hybrid electric, or internal combustion engine (ICE)-powered motor vehicle. In such a configuration, the autonomous vehicle 11 includes a vehicle body 11B and a set of road wheels 11W connected to the vehicle body 11B, with one or more of the road wheels 11W being powered by a prime mover (not shown). The mobile host 10 may be alternatively configured as an automation robot, a mobile platform, farm equipment, a boat, or another mobile system or device in other implementations. Therefore, the vehicular depiction and exemplary description provided below are intended to be illustrative of the present teachings without being limiting thereof.

In accordance with the present teachings, the mobile host 10 of FIG. 1 is equipped with a Visual Simultaneous Localization and Mapping (V-SLAM) system 15. The V-SLAM system 15 may include a sensor suite 14 operable for collecting image frames and other raw input data 140 suitable for use in determining parameters of the mobile host 10 and estimating its current orientation or pose in a surrounding environment 12 of the mobile host 10. The sensor suite 14 as set forth herein may optionally include a global navigation satellite system (GNSS) receiver (Rx) 17R (or a global positioning system (GPS) receiver or another application-suitable positioning data receiver) operable for determining a geospatial position of the mobile host 10 on a route by receiving and processing positioning satellite-based positioning data, e.g., GNSS data or other relevant position data.

The sensor suite 14 may also include an inertial measurement unit (IMU) 19 and/or one or more cameras 24, which collectively sense and output the above-noted input data 140. The camera(s) 24 may include a mono-camera or electrooptical photosensors and/or other suitable image/distance sensors such as lidar, radar, ultra-wideband sensors, etc., with the camera(s) 24 being operable for sensing and outputting image data indicative of features of interest in a surrounding environment of the mobile host 10.

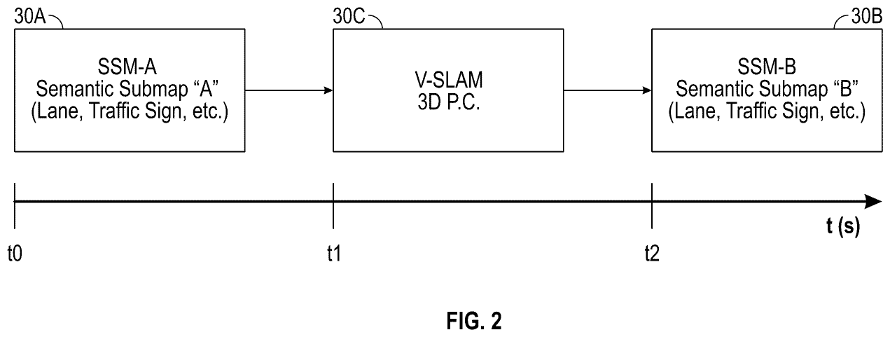

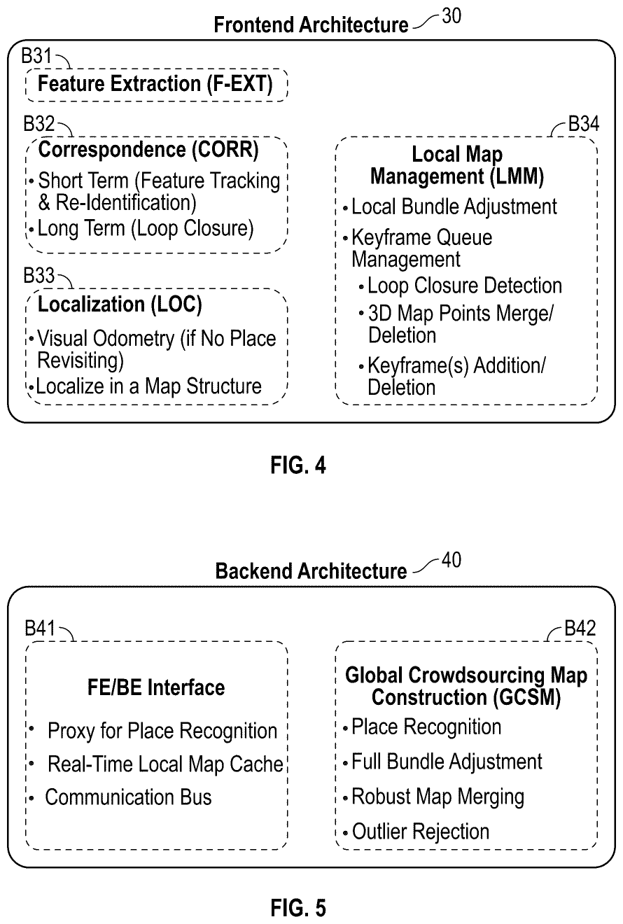

The V-SLAM system 15 of FIG. 1 is configured as set forth below with reference to FIGS. 2-9 to work within the context of a vehicle fleet, i.e., a plurality or multitude of autonomous vehicles 11, to improve navigation accuracy during situations in which the mobile host 10 travels within a positioning signal-denied environment. The mobile host 10 is also equipped with an electronic controller 20, i.e., one or more computer devices that are separate from the V-SLAM system 15 or integral therewith (as shown). Execution of such instructions enables the V-SLAM system 15 to function as a frontend architecture 30 (FIG. 4) working in conjunction with a backend architecture 40 (FIG. 5) to perform the various functions described herein, and possibly to use the controller 20 to control a dynamic state of the mobile host 10 in response to localizing the mobile host 10, i.e., in autonomous vehicle embodiments.

At times, the mobile host 10 of FIG. 1 may operate in a positioning signal-compromised or positioning signal-denied manner (e.g., GNSS signal-denied) within the surrounding environment 12, e.g., an urban canyon. The term “urban canyon” as used herein refers to a city or industrial area in which several multi-story buildings 13 or other tall manufactured or naturally occurring obstructions are arranged along a route of the mobile host 10. Structure not shown in FIG. 1 but well understood in the art such as water towers, elevated roadways, car parks/garages, and the like may similarly combine to form such an urban canyon, or the obstructions may include mountains or other naturally occurring elevated structures.

In the representative signal-compromised environment 12 of FIG. 1, the various buildings 13 may block clear receipt by the receiver 17R of satellite-based positioning data/signals 170 transmitted by an orbiting constellation of geopositioning satellites 17. Materials used to construct the walls, edifices, roofs, and other surfaces of the buildings 13, e.g., glass, steel, concrete, etc., may reflect the signals 170 away from the receiver 17R of the mobile host 10 as multi-path reflections 170R. As a result, navigation and related functions of one or more autonomous systems 18 of the mobile host 10, and thus of the V-SLAM system 15, may operate in a suboptimal manner. The mobile host 10 may operate in other signal-compromised environments 12 in other scenarios, and therefore the urban canyon example of FIG. 1 is intended to be illustrative of the present teachings and non-limiting thereof.

As appreciated by those skilled in the art, the V-SLAM system 15 uses the camera(s) 24 during operation of the mobile host 10 to collect multiple image frames of a given feature and output the same as multi-frame image data 240. Image data collection as part of the input data 140 is represented by arrow AA in FIG. 1, with two imaged scenes I and II shown for simplicity. The image frames have various feature map points 26. Scenes I and II contain the same feature map points 26 at two separate times and/or 3D poses 28 of the mobile host 10 and cameras 24 connected thereto, e.g., to the vehicle body 11B. Corresponding feature map points 26 in each of the image frames are linked, with the linking lines shown generally as LL. In an actual implementation, however, the various scenes may not have corresponding feature map points due to, e.g., occlusion of the camera 24, signal loss, etc.

As represented by arrow BB of FIG. 1, the feature map points 26 are output from the image data 240 provided by the camera(s) 24, and possibly corrected using other data such as IMU data, lidar, radar, etc. The 3D positions of the feature map points 26 are calculated by triangulation with consecutive frames in the image data 240, mainly to estimate their initial positions, which are then optimized simultaneously along with the camera pose or position. The controller 20, which is in communication with the camera 24, includes one or more processors 21 and a computer storage medium (“memory”) 22 containing computer-readable instructions, the execution of which by the processor 21 causes the controller 20 to perform the actions described herein, including localizing the mobile host 10 on a route using the satellite-based location data and a semantic submap when a signal quality of the GNSS receiver 17R exceeds a threshold. When the signal quality does not exceed the threshold, the controller 20 selectively localizes the mobile host 10 on the route at least in part using a crowdsourced three-dimensional (3D) point cloud map 30C of the route (FIG. 2). The V-SLAM system 15 being operable for communicating the image data 240 and positioning data from the GNSS receiver 17R to a cloud-based backend architecture 40 (FIG. 5) operable for generating the crowdsourced 3D point cloud map of the route as set forth below.

The memory 22 includes non-transitory memory or tangible non-transitory computer storage media/devices (read only, programmable read only, solid-state, random access, optical, magnetic, etc.). The memory 22 is capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality.

Additionally with respect to the controller 20 and the V-SLAM system 15, input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions.

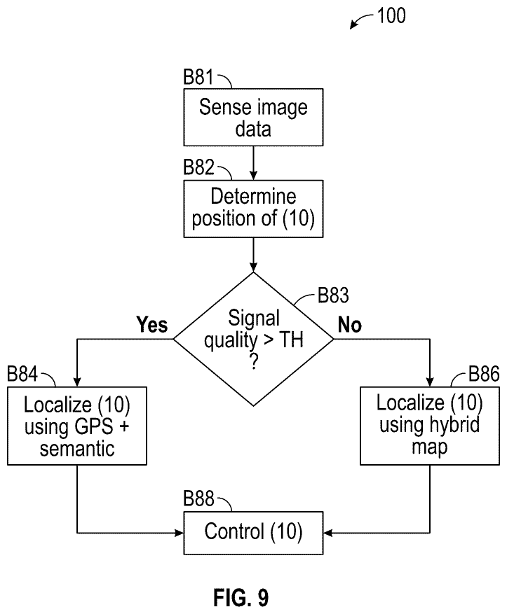

Ultimately, the controller 20 may output a control signal (arrow CC_{O}) containing a filtered feature map point set to a navigation system (NAV) 25 to control a setting of the navigation system 25. The control signal (arrow CC_{O}) in such an implementation is operable for changing a setting of a navigation map for use during possibly autonomous operation of the mobile host 10, with other systems possibly benefitting from the present teachings. When the controller 20 is configured as part of a frontend architecture 30 that is in remote communication with the cloud-based backend architecture 40, the controller 20 may receive a crowdsourced 3D point cloud map of the route, possibly in response to a request from the controller 20 as part of the control signal (arrow CC_{O}) or as a separate electronic signal. Computer readable instructions representative of a method 100 may be recorded in memory 22 and executed by the processor 21 to perform the various functions described herein, with a representative embodiment of the method 100 illustrated in FIG. 9 and described below.

At times, the mobile host 10 of FIG. 1 may operate as part of a fleet of vehicles in an urban canyon or other environment having poor GNSS signal reception, or poor GPS or other positioning signal reception in other embodiments. Each vehicle has its own GNSS receiver 17R and camera 24, and may take multiple passes over time through a given route. Therefore, the present strategy situationally adds 3D feature points to critical regions of semantic submaps for improved accuracy, with the present approach relying on a fusion of 3D point cloud maps and semantic submaps for this purpose. Semantic submaps used in vehicle navigation systems accurately identify and label key features such as road segments and landmarks such as traffic signs and lane markings. A semantic submap captures spatial relationships between the various landmarks, defines road topology and connectivity, and thus supports predictive path planning. When used with GNSS-based navigation, the position of the mobile host 10 is accurately localized along a given route. Location accuracy may drop, however, and planned trajectories of the mobile host 10 may drift, when the GNSS signal is compromised.

Referring briefly to FIG. 2, a general timeline in seconds, i.e., t(s), is shown in which the mobile host 10 of FIG. 1 travels along a route informed by a reliable, continuous satellite or other positioning signal. That is, between t₀ to t₁, the mobile host 10 may be located on the route using a semantic submap A (SSM-A) 30A, describing the locations of lane boundaries, traffic signs, intersections, buildings, etc. At time t₁, however, the mobile host 10 may turn down a street and enter an urban canyon. On some road sections, like the center of intersections, semantic submap elements (e.g., lane boundaries) may be unavailable, GNSS signal strength may decrease, or location capabilities may drop out entirely as signals are blocked by surrounding buildings. After traveling a distance more, the mobile host 10 may emerge from the urban canyon at time t₂, thus resuming travel in accordance with another semantic submap B (SS-B) 30B. The gap between times t₁ and t₂ is considered herein to be a “signal-denied” period. During such a time, the present approach seeks to seamlessly transition from adjacent semantic submap 30A, to hybrid map 30C of semantic and 3D point cloud information constructed using keyframes and crowdsourced 3D feature points as landmarks, and back again to semantic submap 30B once GNSS signal strength/reliability resumes.

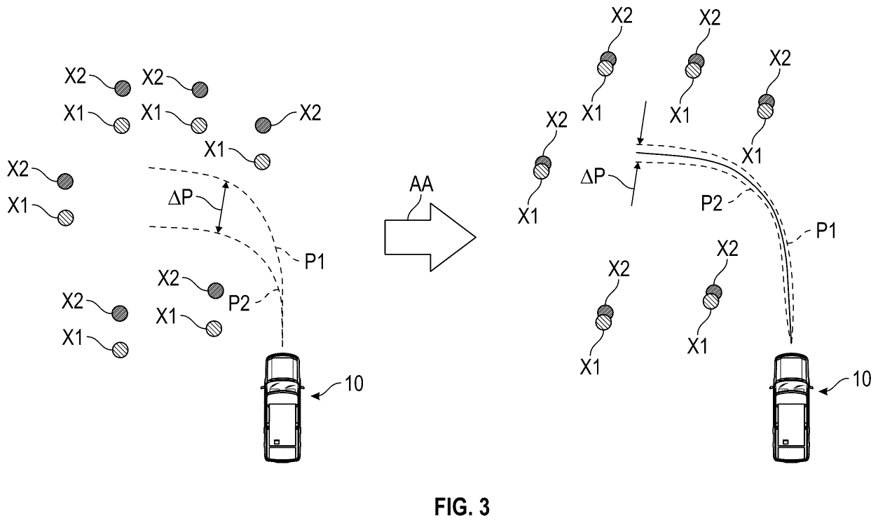

Referring to FIG. 3, the present disclosure as set forth below with reference to FIGS. 4-9 enables a particular V-SLAM architecture which aggregates and aligns crowdsourced sensor data from a fleet of vehicles 11 or other mobile hosts 10 to create hybrid point cloud maps and semantic submaps. In essence, the 3D point clouds are “stitched in” to fill in gaps in the semantic submaps due to poor signal reception. The resulting data effectively fills an information void spanning between times t₁ and t₂ in FIG. 2, and thus supports real-time precise positioning for autonomous vehicles or other mobile hosts 10.

Passes P1 and P2 of the mobile host 10 through a representative urban canyon are respectively determined using a series of map points X1 and X2. As shown, a signal-denied environment may result in positional uncertainty, and thus a significant difference between ground truth and the perception of mobile host 10 during the different passes P1 and P2. Variance or drift between the passes P1 and P2 is represented as ΔP. As positional uncertainty between points X1 and X2 is reduced (arrow AA) using the present holistic V-SLAM approach, so too is the drift (ΔP). A bundle adjustment and data fusion-enabled transition between adjacent semantic submaps and crowdsourced 3D point cloud data is thus crucial to improving location accuracy during times when the mobile host 10 is operating in an urban canyon.

FRONTEND ARCHITECTURE (30): FIG. 4 illustrates a representative embodiment of a frontend architecture 30 of the V-SLAM system 15 of FIG. 1. Block B31 entails feature extraction (F-EXT), i.e., the extraction of feature points indicated at X1 and X2 in FIG. 3. Such points form a 3D point cloud/map and are saved to memory 22. As appreciated in the art, feature extraction is used when creating a 3D point cloud map, and involves various subprocesses including image preprocessing, filtering, and key point detection algorithms, e.g., Features from Accelerated Segment Test (FAST), etc. Points corresponding to unique image characteristics are identified.

In block B31, therefore, the GNSS receiver 17R, the IMU 19, and the camera(s) 24 feed data (as the raw input data 140 of FIG. 1), in an exemplary case GNSS data, IMU data, and image data, into the frontend architecture 30, which in one or more embodiments may be hosted aboard the mobile host 10. The GNSS receiver 17R and the IMU 19 respectively transmit GNSS signals 270 and IMU signals 190 (FIG. 1), e.g., acceleration, pitch, yaw, and roll of the mobile host 10, to a correspondence block B32.

Block B32 (CORR) involves determining short-term and long-term correspondence between features. As used herein, correspondence entails performing feature tracking and identification (short-term) and loop closure (long-term) to match the feature points of block B31 to current views from the camera(s) 24. Block B32 thus establishes correspondences between the key points of block B31, e.g., using descriptor distance matching. Matched features are tracked across multiple image frames. Block B31 may also entail use of a computer vision module operable for detecting features in views of the surrounding environment 12 (FIG. 1). This information may be used at block B33 (LOC), i.e., localization, which determines an initial estimate of 3D poses of the mobile host 10 using camera calibration information, as appreciated in the art.

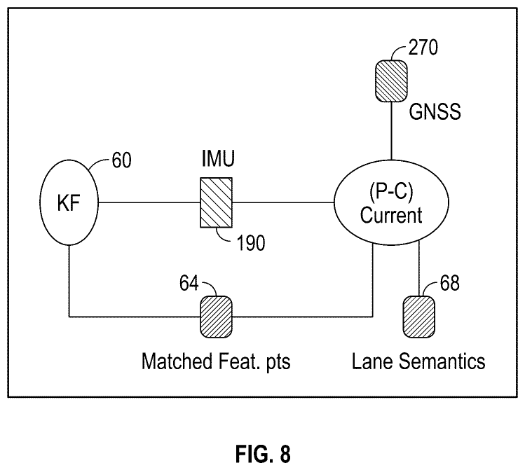

The frontend architecture 30 of FIG. 4 also includes a local map management (LMM) at block B34. As used herein, block B34 is an optimizer of a type appreciated in the art that performs local bundle adjustment for map and trajectory refinement. The controller 20 may be configured to locally optimize camera pose trajectory and key features in the image data, e.g., using GNSS data and IMU data. “Bundles” as used herein may refer to a collection of images frames, e.g., 10-15 image frames, each of which is then matched to the 3D point cloud map reprojection in the image plane with the objective of minimizing the reprojection error. An important measure of optimization robustness is how sensitive the output of a system is to small changes or errors in its input. Minor changes in input such as noise, e.g., visual reprojection factor noise, should result in slight changes in output. Applying condition-based robust techniques, slight changes in estimated visual reprojection noise should yield nearly stable results in terms of accuracy. Block B34 may entail non-linear least squares optimization techniques such as Levenberg-Marquardt, with an example set forth below with reference to FIG. 8. Output signals from block B34 are provided as optimized key frames and optimized 3D feature map points to a backend architecture 40, and embodiment of which will now be described with reference to FIG. 5.

BACKEND ARCHITECTURE (40): FIG. 5 illustrates a possible implementation of a backend architecture 40. Aspects of the backend architecture 40 may be located onboard the mobile host 10 of FIG. 1 in one or more embodiments, or the backend architecture 40 may be partially or entirely cloud-based or fully remote from the mobile host 10. Backend systems such as the backend architecture 40 of FIG. 5 are appreciated in the art, and typically include a frontend/backend (FE/BE) interface block B41, e.g., a real-time map cache and communication bus. Within the backend architecture 40, a global crowdsourcing map (GCSM) construction block B42 may be created and maintained using output signals from a plurality of hosts, e.g., a fleet of autonomous vehicles. Depending on the hardware and processing capabilities of the mobile host, embodiments may be considered in which more of the described functions are offloaded to the backend architecture 40, e.g., the feature extraction block B31, correspondence block B32, and keyframe localization functions of blocks B33 and/or B34.

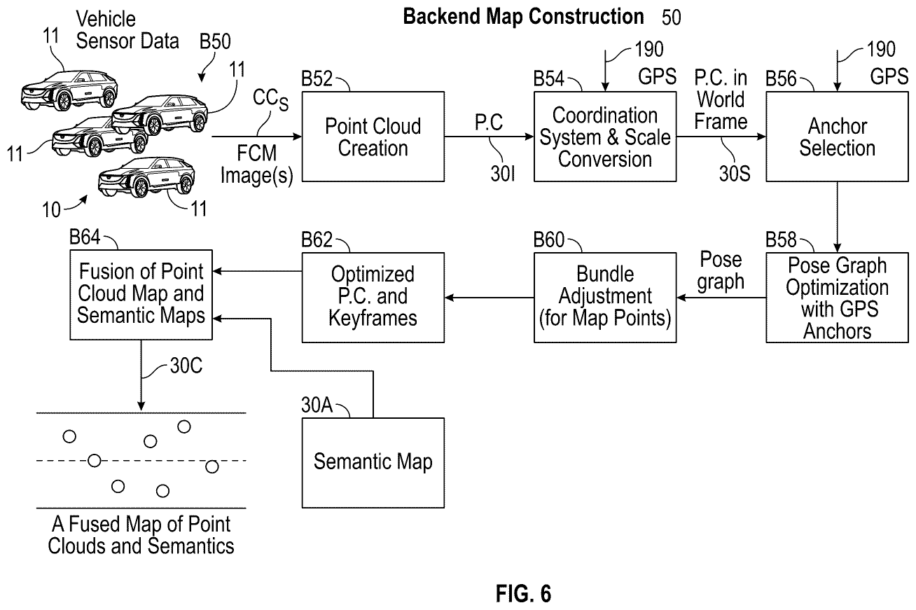

Referring now to FIG. 6, a flow diagram 50 illustrates operation of the representative backend architecture 40 of FIG. 5 when creating a fused map of 3D point clouds and sematic map data in signal-denied environments in accordance with the disclosure. Block B50 entails collecting sensor data (CCs) from a plurality of mobile hosts 10, e.g., a fleet of autonomous vehicles 11. Using the cameras 24 mounted to each of the mobile hosts 10, camera images frames, i.e., multi-frame image data 240 of FIG. 1, are fed into a point cloud creation block B52. The backend architecture 40 uses the camera frames to construct an initial 3D point cloud (P.C.) map 301 of the environment. An initial 3D point cloud map is then output to block B54.

Block B54 includes receiving the GNSS data 270 of the environment 12, to the extent such data is available, and then scaling/converting after associating the point cloud data with the GNSS data 270. Block B54 entails estimating scale, e.g., in meters. Block B54 then outputs a scaled 3D point cloud 30S in a “real world” frame of reference as an input to block B56. Thus, block B56 receives the 3D point cloud 30S with an appropriate scale.

At block B56, the backend architecture 40 selects anchor points for the 3D point cloud map. Such anchor points are keyframes associated at block B54 with a good GNSS signal, where the estimated GNSS variance is small relative to a calibrated threshold. The anchor points are then passed to block B58.

Block B58 performs optimization as noted above, this time using the anchor points from block B56. An optimized pose graph is then communicated to block B60, which performs bundle adjustment for the various map points. Optimized point cloud and keyframes (B62) are then provided to a fusion block B64, where the backend architecture 40 fuses the 3D point cloud map and adjacent semantic submaps for use in signal-denied environments. The output of block B64 is a fused map of 3D point clouds and semantic submaps, with the controller 20 configured to receive the crowdsourced 3D point cloud map of the route as the hybrid/fused map 30C of the 3D point cloud and the semantic submap 30A and/or 30B (FIG. 2). A representative approach for performing blocks B56 and B58 is disclosed in U.S. patent application Ser. No. 18/662,128, which was filed on May 13, 2024, and which is hereby incorporated by reference in its entirety.

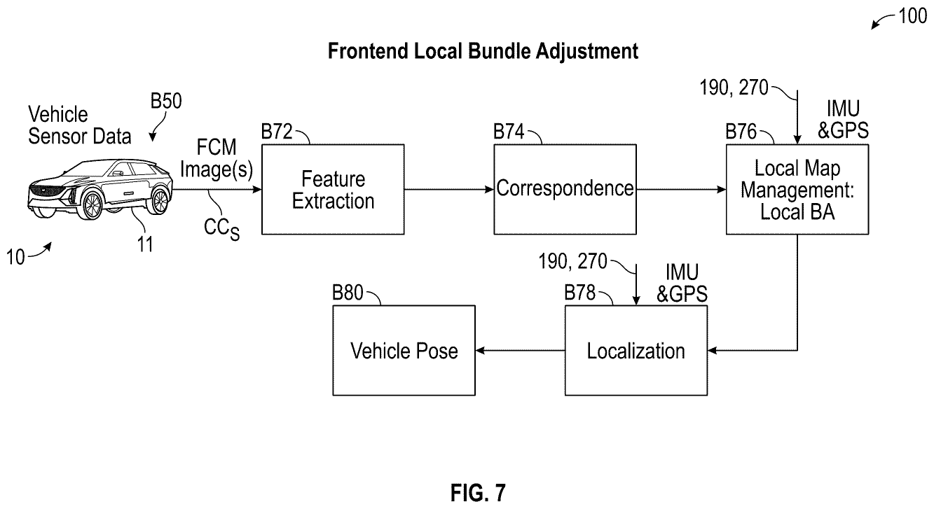

FRONTEND FUNCTION: Referring to FIG. 7, block B50 as described above with reference to FIG. 6 entails collecting sensor data (CCs) from a plurality of mobile hosts 10, e.g., a fleet of autonomous vehicles 11. The camera image frames/image data 240 are fed into a feature extraction block B72 where key features in the various image frames are detected and extracted for use in a 3D point cloud map. Correspondence of these features between different frames is performed at block B74, e.g., a tree in image 1 is determined to correspond to the same tree in image 2. Matching points are then communicated to block B76.

Block B76 (BA) receives IMU data 190 and GNSS data 270 as inputs and performs local map management as noted above with reference to block B34 of FIG. 4. Block B76 may entail performing a graph optimization technique to estimate joints of (i) 3D coordinates of each map point 26, and (ii) camera poses 28 (position and orientation). Block B76 also entails minimizing the reprojection error between the projected initial map point estimates and their corresponding features in a given image frame. Information may be provided from the backend architecture 40 when the same location is later revisited, i.e., for loop closure and accuracy improvement. Block B76 may also optimize locally over a small batch of camera keyframes. In this manner, errors in the map may be minimized or corrected over time as mobile host 10 or other hosts 10 in the fleet revisit the same area of a GNSS signal-denied environment.

Referring briefly to FIG. 8, which illustrates a previous keyframe (KF) 60, IMU data 190, matched feature points 64, GNSS data 270 and lane semantics 68 from semantic submap(s) 30A and/or 30B, block B78 includes performing localization using the pose estimates from block B76. Localization is defined as finding the current pose (P-C) of the mobile host 10/autonomous vehicle 11 such that observation error from the IMU data 190, matched feature points 64, GNSS data 270, and lane semantics 68 is minimized. From this, the various data are fused to calculate the final pose of the mobile host 10 at block B80. The controller 20 in some embodiments, alone or working with the backend architecture 40, is thus configured to estimate a current pose of the mobile host 10 by minimizing error between the IMU data, the GNSS data 270, and the semantic submap.

A goal of localization is to find, given the pose of the previous key frame (KF), i.e., Tₚ, the unknown current pose (T_{q}) such that the following least squares expression is minimized:

$$arg {min}_{T q} ∝ ‖ {o}_{IMU} - {o}_{IMU}^{′} ‖ + β {\sum }_{i} ‖ {q}_{i} - {p}_{i}^{′} ‖ + γ {\sum }_{k} ‖ {s}_{k} - {s}_{k}^{′} ‖ + δ ‖ {t}_{G N S S} - {t}_{G N S S}^{′} ‖$$

where o_{IMU} represents the IMU measurements, o′_{IMU} is the predicted delta or change in such measurements, i.e.,

$${o}_{IMU}^{′} = Log ( {T}_{p}^{- 1} {T}_{q} ) ,$$

represents the feature points from the key frame, p′ᵢ is the projected feature points to the current frame as a function of T_{q}, i.e.,

$${p}_{i}^{′} = {T}_{p}^{- 1} {T}_{q} {p}_{i} ,$$

{qᵢ} is the matched feature points, lane semantics are represented by polyline points {sᵢ} in a global coordinate frame, projected points

$${s}_{k}^{′} = {T}_{q}^{- 1} {s}_{k} ,$$

t_{GNSS} is the measured GNSS position, and t′_{GNSS}=T_{q}0, where 0 is the zero vector.

Referring briefly to FIG. 9, using the above approach one skilled in the art may envision a V-SLAM method 100 for the mobile host 10. The method 100 is described for simplicity as a series of algorithm code segments or logic blocks each executable by the processor 21 of FIG. 1. An exemplary implementation of the method 100 may begin with block B81 with sensing and outputting image data via the camera 24 of the mobile host 10, with the image data being indicative of features of interest in a surrounding environment of the mobile host 10. The method 100 then proceeds to block B82 where the method 100 includes determining a position of the mobile host 10 on a route as GNSS data 270 using the GNSS receiver 17R of the mobile host 10 or another suitable receiver.

The method 100 may determine at block B83 whether a signal quality of the signal 170 carrying the GNSS data 270 exceeds a threshold, e.g., based on signal strength, continuity, or number of satellites in line-of-sight of the GNSS receiver 17R. The method 100 proceeds to block B84 when the signal quality exceeds the threshold. The method 100 proceeds in the alternative to block B86 when the signal quality does not exceed the threshold.

At block B84, the method 100 includes localizing the mobile host 10 on the route using the GNSS data 270 and a semantic submap when the signal quality of the receiver 17R exceeds the threshold noted above in block B83. The method 100 then proceeds to block B88.

At block B86, when the signal quality does not exceed the threshold, the method 100 includes selectively localizing the mobile host 10 on the route via the controller 20 of V-SLAM system 15. This action may be taken at least in part using a crowdsourced 3D point cloud map of the route. The controller 20 in this instance is operable for communicating the image data 240 and the GNSS data 270 to the cloud-based backend architecture 40, which for its part is operable for generating the hybrid crowdsourced 3D point cloud map 30B of the route.

At block B88, the method 100 may optionally include controlling a dynamic state of the mobile host 10, e.g., by controlling speed, steering, braking, or other parameters. Such a step may be used when the mobile host 10 is constructed as an autonomous vehicle 11 as noted above.

The proposed solutions therefore allow the leveraging of cloud resources, including possible offloading of computational resources to the backend architecture 40, for the purpose of receiving “pose fixes” from the cloud in GNSS-denied environments. The disclosure therefore provides an alternative localization strategy that seamlessly transitions from sematic maps to aggregated and aligned, crowdsourced V-SLAM localization based on 3D point clouds in areas of poor GNSS signal reception, and then back again to an adjacent semantic submap. The use of hybrid point cloud maps and semantic submaps thus provide real-time precise positioning for autonomous vehicles. These and other benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A Visual Simultaneous Localization and Mapping (V-SLAM) system for a mobile host, comprising:
a camera operable for sensing and outputting image data indicative of features of interest in a surrounding environment of the mobile host;
a global navigation satellite system (GNSS) receiver operable for determining a position of the mobile host on a route by receiving GNSS data; and
a controller in communication with the camera, wherein the controller includes a processor and a computer storage medium (“memory”) containing computer-readable instructions, and wherein execution of the instructions by the processor causes the controller to:
localize the mobile host on a route using the GNSS data and a semantic submap when a signal quality of the GNSS receiver exceeds a threshold; and
when the signal quality does not exceed the threshold, selectively localize the mobile host on the route at least in part using a crowdsourced three-dimensional (3D) point cloud map of the route, wherein V-SLAM system is operable for communicating the image data and the GNSS data to a cloud-based backend architecture operable for generating the crowdsourced 3D point cloud map of the route.

2. The V-SLAM system of claim 1, wherein the mobile host is an autonomous vehicle, and wherein the controller is operable for controlling a dynamic state of the autonomous vehicle in response to localizing the mobile host.

3. The V-SLAM system of claim 1, wherein the controller is configured as part of a frontend architecture that is in remote communication with the cloud-based backend architecture, and is configured to receive the crowdsourced 3D point cloud map of the route in response to a request from the controller.

4. The V-SLAM system of claim 3, wherein the controller is configured to receive the crowdsourced 3D point cloud map of the route as a fused map of the 3D point cloud map and the semantic submap.

5. The V-SLAM system of claim 1, further comprising an inertial measurement unit (IMU) operable for outputting IMU data, wherein the controller is configured to locally optimize key features in the image data using the GNSS data and the IMU data.

6. The V-SLAM system of claim 5, wherein the controller is configured to estimate a current pose of the mobile host by minimizing errors between the IMU data, the 3D point cloud map, and the semantic submap.

7. The V-SLAM system of claim 6, wherein the controller is configured to minimize the errors by minimizing a least squares expression of the IMU data, the 3D point cloud map, and the semantic submap.

8. A Visual Simultaneous Localization and Mapping (V-SLAM) method for a mobile host, comprising:
sensing and outputting image data via a camera of the mobile host, the image data being indicative of features of interest in a surrounding environment of the mobile host;
determining a position of the mobile host on a route as global navigation satellite system (GNSS) data using a GNSS receiver of the mobile host;
localizing the mobile host on the route using the GNSS data and a semantic submap when a signal quality of the GNSS receiver exceeds a threshold; and
when the signal quality does not exceed the threshold, selectively localizing the mobile host on the route via a controller of a V-SLAM system at least in part using a crowdsourced three-dimensional (3D) point cloud map of the route, and communicating the image data and the GNSS data to a cloud-based backend architecture via a controller, the cloud-based backend architecture being operable for generating the crowdsourced 3D point cloud map of the route.

9. The method of claim 8, further comprising:
controlling a dynamic state of the mobile host in response to localizing the mobile host, wherein the mobile host is an autonomous vehicle.

10. The method of claim 8, further comprising:
receiving the crowdsourced 3D point cloud map of the route from the cloud-based backend architecture in response to a request from the controller.

11. The method of claim 10, further comprising:
receiving the crowdsourced 3D point cloud map of the route as a fused map of the 3D point cloud and the semantic submap.

12. The method of claim 8, further comprising:
locally optimizing key features in the image data using the GNSS data and inertial measurement unit (IMU) data.

13. The method of claim 12, further comprising:
estimating a current pose of the mobile host by minimizing errors between the IMU data, the 3D point cloud map, and the semantic submap.

14. The method of claim 13, wherein minimizing the error includes minimizing a least squares expression of the IMU data, the 3D point cloud map, and the semantic submap.

15. A Visual Simultaneous Localization and Mapping (V-SLAM) system, comprising:
a frontend architecture having:
a camera mounted to a mobile host, the camera being operable for sensing and outputting image data indicative of features of interest in a surrounding environment of the mobile host;
a global navigation satellite system (GNSS) receiver operable for determining a position of the mobile host on a route as GNSS data; and
a controller in communication with the camera and the GNSS receiver, and operable for communicating the image data and the GNSS data to a cloud-based backend architecture; and
the cloud-based backend architecture, wherein the cloud-based backend architecture is operable for aggregating and aligning crowdsourced sensor data from a plurality of mobile hosts into a crowdsourced 3D point cloud map, wherein the V-SLAM system is operable for:
localizing the mobile host on a route using the GNSS data and a semantic submap when a signal quality of the GNSS receiver exceeds a threshold; and
when the signal quality does not exceed the threshold, selectively localizing the mobile host on the route at least in part using the crowdsourced 3D point cloud map of the route.

16. The V-SLAM system of claim 15, wherein:
the mobile host is an autonomous vehicle;
the controller is operable for controlling a dynamic state of the autonomous vehicle in response to localizing the mobile host; and
the cloud-based backend architecture is operable for aggregating and aligning the crowdsourced sensor data from the plurality of mobile hosts as a fleet of autonomous vehicles.

17. The V-SLAM system of claim 15, wherein the controller is configured as a frontend architecture that is in remote communication with the cloud-based backend architecture, and is configured to receive the crowdsourced 3D point cloud map of the route in response to a request from the controller, and wherein the controller is configured to receive the crowdsourced 3D point cloud map of the route as a fused map of the 3D point cloud and the semantic submap.

18. The V-SLAM system of claim 15, wherein the frontend architecture includes an inertial measurement unit (IMU) operable for outputting IMU data, and wherein the controller is configured to locally optimize key features in the image data using the GNSS data and the IMU data.

19. The V-SLAM system of claim 18, wherein the controller of the frontend architecture is configured to estimate a current pose of the mobile host by minimizing error between the IMU data, the 3D point cloud map, and the semantic submap.

20. The V-SLAM system of claim 19, wherein the controller is configured to minimize the error by minimizing a least squares expression of the IMU data, the 3D point cloud map, and the semantic submap.
